(19) United States
(12) Patent Application Publication
(10) Pub. No.: US 2023/0088798 A1
(43) Pub. Date: Mar. 23, 2023

(54) BLOWER

(71) Applicant: LG ELECTRONICS INC., Seoul (KR)

(72) Inventors: Jaehyuk JUNG, Seoul (KR); Changhoon LEE, Seoul (KR); Seokho CHOI, Seoul (KR)

(21) Appl. No.: 17/795,647

(22) PCT Filed: May 27, 2020
(86) PCT No.: PCT/KR2020/006821

§ 371 Date: Jul. 27, 2022

(30) Foreign Application Priority Data
Jan. 31, 2020 (KR) 10-2020-0011778

(51) Int. Cl. F04D 29/46; F04D 25/10; F04D 27/00

(52) U.S. Cl. CPC F04D 29/462; F04D 25/10; F04D 27/00

(57) ABSTRACT

An air blower according to an embodiment of the present invention comprises: a support body through which a suction part is formed; a tower coupling part which is formed above the support body and in which a rotation module is installed; a dual discharge part which is coupled to the rotation module and includes a first discharge tower and a second discharge tower extending upward from the support body to be symmetrical to each other; and a control part which individually controls the rotation of the dual discharge part, wherein the control part can control the rotation angles of the first discharge tower and the second discharge tower so that air discharged from the first discharge tower and air from the second discharge tower is mixed, and the mixed air has an air volume larger than that of the air discharged from any one discharge tower among the first discharge tower and the second discharge tower.

### TECHNICAL FIELD

The present disclosure relates to a blower.

### BACKGROUND ART

In general, a blower is a mechanical device that drives a fan to generate a flow of air. For example, the blower may include blades that rotate about a rotating shaft. The blower may generate a flow of air by the rotation of the blade.

The blower may be disposed relatively close to a user in a room such as a home or an office. In this case, the blower is usually referred to as a “fan.” The flow of air generated by the blower may release heat in the room through convection and evaporation. Accordingly, the user in the room may feel cool and comfortable.

On the other hand, the conventional blower is visually provided with a blade attached to the rotating shaft, and is provided with a protective net mechanism such as a cage to prevent a safety accident related to the blade. However, the cage and blade are easily contaminated and inconvenient to manage. Accordingly, recently, various blowers (or fans) in which the blades of the blower are invisible to the user's eyes have been disclosed.

In addition, the conventional blower may include a filter device for filtering dust and the like provided therein. In this case, the blower may perform indoor air cleaning.

As the related art documents related thereto, Korean Patent Laid-Open Publication No. 10-2011-0100274 (published on Sep. 9, 2011), Korean Patent Laid-Open Publication No. 10-2019-0015325 (published on Feb. 13, 2019), and Korea Patent Laid-Open Publication No. 10-2019-0025443 (published on Mar. 11, 2019).

On the other hand, the conventional blower simply increases a wind velocity or an air volume by controlling a rotation velocity of a motor when it is intended to provide a stronger wind to the user.

### DISCLOSURE

### Technical Problem

The present disclosure provides a hidden blower in which wings (or blades) of a rotating fan are non-visually provided.

Another object of the present disclosure provides a blower capable of implementing various blowing modes by individually rotating a dual discharge part.

Still another object of the present disclosure provides a blower that controls a rotation angle of a dual discharge part to maximize air volume.

Yet another object of the present disclosure provides a blower capable of solving a problem of a non-uniform velocity of air sucked according to a height of a suction part.

### Technical Solution

A blower may include: a support body through which a suction part is formed; a tower coupling part which is formed above the support body and in which a rotation module is installed; a dual discharge part which is coupled to the rotation module and includes a first discharge tower and a second discharge tower extending upward from the support body to be symmetrical to each other; and a control part which individually controls the rotation of the dual discharge part, in which the control part may control rotation angles of the first discharge tower and the second discharge tower so that air discharged from the first discharge tower and air discharged from the second discharge tower is mixed, and the mixed air has an air volume larger than that of the air discharged from any one of the first discharge tower and the second discharge tower.

The control part may control the rotation angles of the first discharge tower and the second discharge tower so that the mixed air has noise lower than that generated by the air discharged from any one of the first discharge tower and the second discharge tower.

The dual discharge part may further include: a first discharge slit which is formed to extend vertically to the first discharge tower and discharges air; and a second discharge slit which is formed to extend vertically to the second discharge tower and discharges air.

An imaginary reference line S that bisects between the first discharge tower and the second discharge tower may be defined, the rotation angle of the first discharge tower is 0° when the first discharge slit may be directed in a direction parallel to the reference line, and the rotation angle of the second discharge tower may be 0° when the second discharge slit is directed in a direction parallel to the reference line.

The first discharge tower or the second discharge tower may define a rotation angle having a positive value from the reference line S as a diffusion angle, and the control part may rotate the first discharge tower and the second discharge tower, respectively, so that the diffusion angle satisfies a preset range.

The rotation angle of the first discharge tower may have a positive value when rotating clockwise, and the rotation angle of the second discharge tower may have a positive value when rotating counterclockwise.

A preset range of the diffusion angle may be 0° or more and 10° or less.

The control part may control the diffusion angle of the first discharge tower and the diffusion angle of the second discharge tower 60 to be equal to each other.

The preset range of the diffusion angle may be defined as a sum of the diffusion angle of the first discharge tower and the diffusion angle of the second discharge tower.

The sum of the diffusion angle of the first discharge tower and the diffusion angle of the second discharge tower may be 0° or more and 20° or less.

The control part may control the diffusion angle of the first discharge tower and the diffusion angle of the second discharge tower to be equal to or different from each other within a preset range of the diffusion angle.

The suction part may include a plurality of suction holes that are perforated, and the plurality of suction holes may be formed to have different diameters according to a height of the suction part.

The support body may include a cylindrical case forming an appearance, and the suction part may be formed below the lower portion of the case along a circumferential direction.

A maximum height of the suction part may be 76% of a height of the case.

The plurality of suction holes may have a diameter decreasing toward the upward.

The plurality of suction holes may be formed to have different diameters for each section divided according to the height of the suction part.

The suction holes positioned in the same section among the plurality of suction holes may have the same diameter.

The suction part may include a first section positioned at a highest height according to the height of the suction part and a second section positioned below the first section.

A diameter of the suction hole positioned in the first section may be smaller than that of the suction hole positioned in the second section.

The suction part may further include a third section which is positioned below the second section and a fourth section which is positioned below the third section and positioned lowest.

The suction hole positioned in the third section may be greater than a diameter of the suction hole positioned in the second section and smaller than a diameter of the suction hole positioned in the fourth section.

The diameter of the suction hole positioned in the fourth section may be greater than 4.8 mm, and the diameters of the suction holes positioned in the first section to the third section may be smaller than 4.8 mm.

### Advantageous Effects

According to the present disclosure, it is possible to improve safety of a product and achieve advancement of the product with a more stable and neat appearance because blades of a rotating fan are not visible from a user's view.

According to the present disclosure, it is possible to provide pleasant wind to a large number of users positioned in various directions by a dual discharge part that may be rotated individually.

According to the present disclosure, a dual discharge part that may be rotated individually may be controlled with a preset rotation angle to provide a maximum air volume to a user. Therefore, it is possible to increase an air volume only by rotating a dual discharge part without the need to increase a rotation velocity of a fan. Accordingly, it is possible to relatively reduce power consumption.

According to the present disclosure, since the wind of air passing through a suction part becomes relatively uniform according to a height, it is possible to reduce a flow loss and noise, and maximize the amount of air intake.

According to the present disclosure, it is reliably supported from a floor to prevent the risk of overturning.

### DESCRIPTION OF DRAWINGS

FIGS. 1 and 2 are perspective views schematically illustrating a configuration of a blower according to an embodiment of the present disclosure.

FIG. 3 is a cross-sectional view taken along line 1-1′ of FIG. 1.

FIG. 4 is a top view illustrating a state that a dual discharge part of the blower according to the embodiment of the present disclosure discharges air individually.

FIG. 5 is a top view illustrating a state in which the dual discharge part of the blower according to an embodiment of the present disclosure discharges air to form a concentrated wind.

FIG. 6 is an experimental graph measuring an air volume and noise of the blower according to a change in a diffusion angle according to an embodiment of the present disclosure.

FIG. 7 is an enlarged view illustrating a suction part of the blower according to the embodiment of the present disclosure.

FIG. 8 is an experimental graph comparing a passage velocity distribution of air in the case where a diameter of a suction hole is the same and the case where the diameter of the suction hole varies according to the embodiment of the present disclosure.

FIG. 9 is an experimental graph comparing a passage velocity of air in the experiment of FIG. 8.

### MODE FOR DISCLOSURE

Hereinafter, some embodiments of the present disclosure will be described with reference to the exemplary drawings. It is to be noted that in giving reference numerals to components of the accompanying drawings, the same components will be denoted by the same reference numerals even though they are illustrated in different drawings. In describing the embodiment of the present disclosure, when it is determined that a detailed description of related known functions or configurations may obscure the subject matter of the present disclosure, the detailed description thereof will be omitted.

In addition, in describing the components of the embodiment of the present disclosure, terms such as first, second, A, B, (a), (b), etc., may be used. These terms are used only in order to distinguish any component from other components, and features, sequences, or the like, of corresponding components are not limited by these terms. When it is mentioned that any component is “connected” or “coupled” to another component, it is to be understood that any component is directly connected or coupled to another component or is connected or coupled to another component with the other component interposed therebetween.

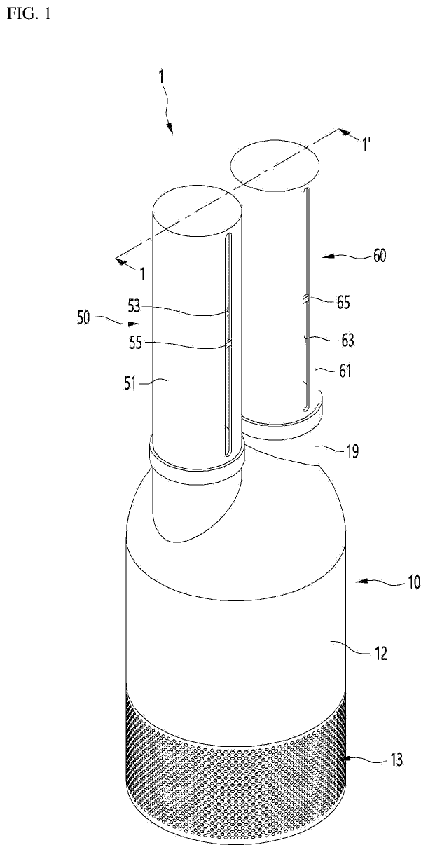

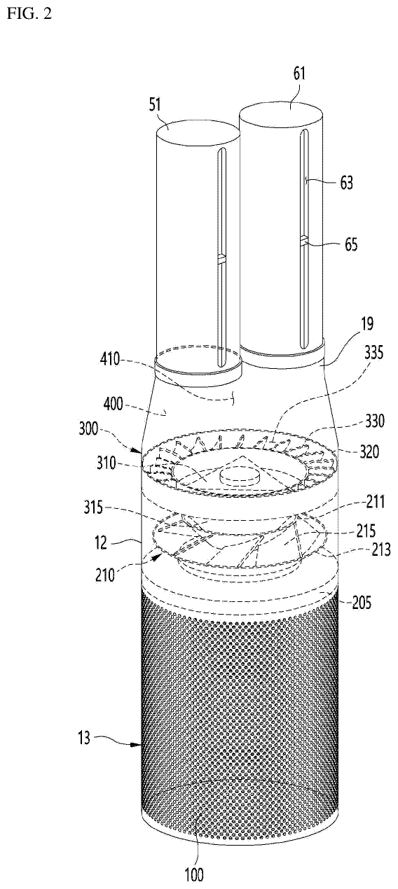

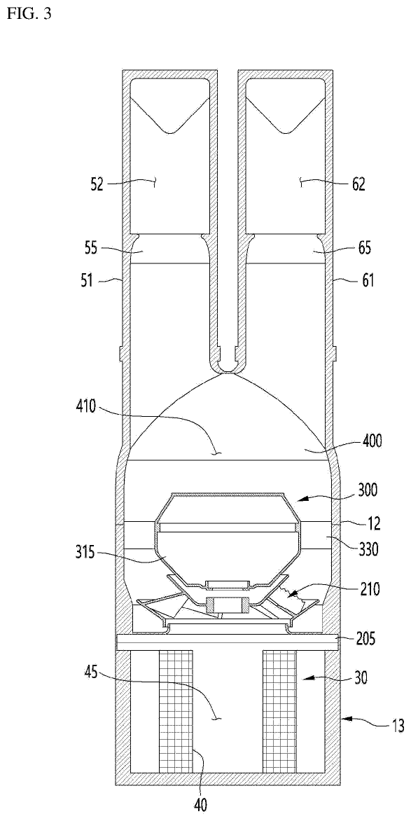

FIGS. 1 and 2 are perspective views schematically illustrating a configuration of a blower according to an embodiment of the present disclosure, and FIG. 3 is a cross-sectional view taken along 1-1′ of FIG. 1.

Referring to FIGS. 1 to 3, a blower 1 according to an embodiment of the present disclosure may include a support body 10 and dual discharge parts 50 and 60 supported by the support body 10.

The support body 10 may form a lower portion of the blower 1, and the dual discharge parts 50 and 60 may form an upper portion of the blower 1.

The dual discharge parts 50 and 60 may form discharge ports 53 and 63 capable of discharging air to the outside, respectively. The discharge port may be understood as “discharge slits 53 and 63” to be described later.

The discharge slits 53 and 63 formed in the dual discharge parts 50 and 60 may discharge air from the front of the blower 1. Meanwhile, the discharge slits 53 and 63 may be referred to as “front discharge ports.”

The dual discharge parts 50 and 60 may be coupled to an upper portion of the support body 10. That is, the dual discharge parts 50 and 60 may discharge air at a position higher than the support body 10.

The dual discharge parts 50 and 60 include tower cases 51 and 61 forming an appearance, discharge slits 53 and 63 forming openings having a predetermined width in the tower cases 51 and 61, and vanes 55 and 65 for guiding air discharged to the slits 53 and 63 in a vertical direction.

The discharge slits 53 and 63 may extend long in the vertical direction of the cases 51 and 61. In addition, air flowing through the inside of the blower 1 may be discharged through the discharge slits 53 and 63.

The plurality of vanes 55 and 65 may be spaced apart from each other in the extending direction of the discharge slits 53 and 63. That is, the plurality of vanes 55 and 65 may be disposed in a height direction of the tower cases 51 and 61.

The vanes 55 and 65 may be installed inside the tower cases 51 and 61 to be rotatable in the vertical direction. In addition, the air introduced into the tower cases 51 and 61 may pass through the discharge slits 53 and 63 according to the guides of the vanes 55 and 65 while rising.

A lower surface of the vanes 55 and 65 may be formed in a curved surface to guide to the discharge slits 53 and 63.

In addition, front end portions of the vanes 55 and 65 may be provided to contact the discharge slits 53 and 63 in a direction perpendicular to the extending direction of the discharge slits 53 and 63. Therefore, the air flowing upward from the inside of the tower cases 51 and 61 may be sequentially discharged by the guides of the vanes 55 and 65 spaced apart in the vertical direction along the discharge slits 53 and 63.

The dual discharge parts 50 and 60 may form dual discharge ports. In detail, the dual discharge parts 50 and 60 may include a first discharge tower 50 and a second discharge tower 60 that are symmetrical to each other.

The first discharge tower 50 and the second discharge tower 60 may be formed to have the same configuration. Accordingly, the following description of any one of the first discharge tower 50 and the second discharge tower 60 may be referred to for the description of the other one.

The first discharge tower 50 and the second discharge tower 60 are provided as a pair and may be coupled to the upper portion of the support body 10, respectively.

Also, the first discharge tower 50 and the second discharge tower 60 may rotate independently of each other. Accordingly, the air discharged by the first discharge tower 50 and the second discharge tower 60 may flow in different directions, respectively.

The first discharge tower 50 may include a first tower case 51 forming an appearance, a first discharge slit 53 formed in the first tower case 51, and a first vane 55 for guiding the air discharged from the first discharge slit 53 in the vertical direction.

The first tower case 51 may have a cylindrical shape. The first tower case 51 may be coupled to the upper portion of the support body 10.

The first discharge slit 53 may extend long in the vertical direction, that is, in the height direction of the first tower case 51. The first discharge slit 53 may be formed as an opening having a preset width in the first tower case 51. The first discharge slit 53 may discharge the air flowing inside the first tower case 51 to the outside.

An end of the first vane 55 may contact an inner side of the first discharge slit 53 in a direction perpendicular to the extending direction of the first discharge slit 53.

The first vane 55 may be rotatably provided. That is, the end of the first vane 55 may be rotatably provided in the vertical direction. Accordingly, when the air discharged from the first discharge slit 52 forms a straight flow in the horizontal direction, the end of the first vane 55 may be in contact with the inner surface of the first discharge slit 53. In addition, the first vane 55 may rotate up and down based on a contact point with the first discharge slit 53. Accordingly, the vertical flow direction of the air discharged from the first discharge slit 53 can be determined.

A plurality of first vanes 55 may be provided, and the plurality of first vanes 55 may be vertically spaced apart from each other along the first discharge slit 53.

The first vane 55 may be positioned in an inner space of the first tower case 51. In addition, the air flowing through the inner space of the first tower case 51 may be guided to the first discharge slit 53 to be discharged to the outside.

Similarly, the second discharge tower 60 may include a first tower case 61 forming an appearance, a first discharge slit 63 formed in the second tower case 61, and a second vane 65 for guiding the air discharged from the first discharge slit 53 in the vertical direction.

As described above, the second tower case 61 is disposed to be symmetrical with the first tower case 51, and may have the same cylindrical shape as the first tower case 51. The description of the second discharge slit 63 and the second vane 65 will cite the description of the first discharge slit 53 and the first vane 55 described above.

The support body 10 may include a case 12 forming an appearance.

The case 12 may form an appearance having a sense of unity with the first tower case 51 and the second tower case 61. For example, the case 12 may have a cylindrical shape. The case 12 may be formed so that the upper portion has a hemispherical shape. On the other hand, the case 12 may be called a “body case.”

A tower coupling part 19 may be positioned on the upper portion of the case 12. Since the dual discharge parts 50 and 60 are coupled to the tower coupling part 19, the dual discharge parts 50 and 60 may be formed in pair to correspond to the dual discharge parts 50 and 60.

The tower coupling part 19 may protrude upward from the upper surface of the case 12.

The support body 10 may further include a suction part 13 formed in the case 12 to suck air. The suction part 13 may be positioned below the case 12. The suction part 13 may be integrally formed with the case 12. For example, the suction part 13 may be formed along a circumferential direction on a lower outer circumferential surface of the case 12.

The suction part 13 may include a suction hole 100 that is perforated to allow air to pass therethrough. The suction hole 100 may be formed in plurality. The plurality of suction holes 100 may be disposed to be spaced apart from each other in a circumferential direction.

In addition, the plurality of suction holes 100 may be formed up to a predetermined height of the case 12. Here, the predetermined height of the case 12 may also be understood as the height of the suction part 13. In addition, the plurality of suction holes 100 may be disposed to be spaced apart in the vertical direction (or the height direction).

Accordingly, the ambient air of the case 12 may be introduced into the inside of the case 12 through the suction part 13 and pass through the filter 40.

As described above, an upper surface of the case 12 may be formed to have a hemispherical curvature. That is, the upper portion of the case 12 may be formed so that a flow cross-sectional area of the rising air becomes smaller as it goes toward the dual discharge parts 50 and 60.

Accordingly, it is possible to relatively reduce a pressure loss with respect to the internal air flowing into the dual discharge parts 50 and 60.

In addition, since the upper surface of the case 12 is shaped like a spherical surface having a curvature, it may smoothly flow into the inner space of the dual discharge parts 50 and 60.

That is, since air flows into the inner space of the dual discharge parts 50 and 60 along the curved surface, friction or collision may be minimized in the air flow process.

Meanwhile, the blower 1 is a control part (not illustrated) capable of controlling each configuration, such as the rotation of the dual discharge parts 50 and 60, the rotation of the discharge slits 53 and 63, and a rotation speed of a fan 210.

The control part (not illustrated) may control each configuration so that various operation modes of the blower 1 are provided. For example, the operating mode of the blower 1 may include a dual wind in which the dual discharge parts 50 and 60 form an individual discharge air flow, a surface wind in which noise is reduced and a soft discharge air flow is formed, a diffused wind (or wide airflow) that maximizes a reach area of an airflow by forming each discharge airflow of the dual discharge parts 50 and 60 into one mixed airflow, and a concentrated wind that maximizes an air volume (or wind speed) by forming each discharge airflow of the dual discharge parts 50 and 60 into one mixed air stream.

For example, the control part may provide the concentrated wind or the diffused wind by controlling the rotation angle of the first discharge tower 50 and the second discharge tower 60.

The support body 10 may further include a filter support part 30 disposed above a base (not illustrated) placed on the ground and a filter 40 coupled to the filter support 30.

Air sucked through the suction part 13 may pass through the filter 40 and flow into a central suction passage 45. That is, the filter 40 may filter (or purify) the air sucked through the suction part 13.

The filter 40 may have a donut or cylindrical shape that is opened along a central axis. The air sucked through the suction part 13 may pass through the outer circumferential surface of the filter 40 having a cylindrical shape and be introduced thereinto.

On the other hand, a suction passage 45 for guiding the filtered air may be formed in the space formed inside the filter 40. That is, the air passing through the filter 40 may flow into the fan 210 along the suction passage 45.

The filter support part 30 may be coupled to an upper surface of the base. The filter support part 30 may include a support device (not illustrated) and a filter frame (not illustrated) that form a mounting space for the filter 40. In detail, the support device may form a lower portion of the filter support part 30. The filter frame may form the upper portion of the filter support 30. In addition, the support device may fix the filter 40.

The support body 10 may further include the fan 210 which is positioned above the filter 40 and provides flow pressure so that air is sucked into the suction part 13, a diffuser 300 which is positioned above the fan 210, and a distribution duct 400 which guides the air passing through the diffuser 300 to the dual discharge parts 50 and 60.

The fan 210 may be accommodated in a fan housing (not illustrated) disposed on an outlet side of the filter 40. For example, the fan housing may be supported by the filter frame. An inlet grill 205 for guiding the inflow of air may be installed at a lower portion of the fan housing. The inlet grill 205 may communicate with the suction passage 45.

The fan 210 may provide a flow pressure of air through the rotation. For example, the fan 210 may be disposed above the inlet grill 205.

In addition, the fan 210 may include a double flow fan that introduces air in an axial direction and discharges air in an oblique direction.

In detail, the fan 210 may include a hub 211 to which a shaft of a motor (not illustrated) is coupled, a shroud 213 which is spaced apart from the hub 211, and a plurality of blades 215 which are disposed between the hub 211 and the shroud 213.

The motor is installed in a motor accommodating part 310 of the diffuser 300, and the shaft of the motor extends downward to be coupled to the hub 211.

The hub 211 may be formed in a shape corresponding to the motor accommodating part 310. For example, the hub 211 may have a bowl shape in which the diameter becomes narrower downward.

In addition, the hub 211 may form a shaft coupling part (not illustrated) to which the shaft of the motor is coupled. The shaft coupling part may be formed on an inner circumferential surface of the hub 211.

The shroud 213 may form a central opening through which the air passing through the inlet grill 205 is sucked. In addition, the shroud 213 may form an outer opening through which the air introduced through the central opening is discharged in an oblique direction by the guide of the blade 215. The outer opening may be positioned above the central opening.

One surface of the blade 215 may be coupled to an outer circumferential surface of the hub 211, and the other surface may be coupled to an inner circumferential surface of the shroud 213.

The plurality of blades 215 may be disposed to be spaced apart from each other in a circumferential direction of the hub 211.

The air passing through the filter 40 may be introduced into the fan 210 through the inlet grill 205 while flowing upward along the suction passage 45. In addition, the air introduced into the central opening (or axial direction) formed by the shroud 213 may be discharged in an oblique direction through the blade 215. In this case, the blade 215 may extend in an oblique direction with respect to the axial direction so that air may flow in an oblique direction through the outer opening.

The diffuser 300 may be positioned above the fan 210. In addition, the diffuser 300 may guide the flow of air passing through the fan 210 to the inner space of the distribution duct 400.

The diffuser 300 may guide the air passing through the fan 210 to the discharge slits 53 and 63.

The diffuser 300 may include an outer wall 320 forming an outer circumference and a motor accommodating part 310 which is positioned on an inner side of the outer wall 320 and extends in a circumferential direction. In addition, the diffuser 300 may further include a plurality of guide vanes 330 provided in a circumferential direction between the motor accommodating part 310 and the outer wall 320.

A diameter of the outer wall 320 is greater than a diameter of the motor accommodating part 310. That is, the diameter of the outer wall 320 may be understood as the outer diameter of the diffuser 300. Also, the diameter of the outer peripheral surface of the motor accommodating part 310 may be understood as the inner diameter of the diffuser 300.

The outer wall 320 may be positioned radially spaced apart from the outer circumferential surface of the motor accommodating part 310. A guide passage 335 through which the air passing through the fan 210 flows may be formed between the inner peripheral surface of the outer wall 320 and the outer peripheral surface of the motor accommodating part 310. In addition, the guide vanes 330 for guiding air upward may be disposed in the guide flow path 335.

The motor accommodating part 310 may form an inner space. In addition, the motor (not illustrated) may be installed in the inner space of the motor accommodating part 310.

A lower portion 315 of the motor accommodating part 310 may have a bowl shape in which a diameter becomes smaller as it goes downward.

The shape of the lower portion 315 of the motor accommodating part 310 may correspond to the shape of the hub 211. In addition, the motor accommodating part 310 may be positioned on the inner side of the hub 211.

The shaft of the motor may extend downwardly from the motor and may be coupled to the shaft coupling part of the hub 211 through a motor coupling hole 318 formed in a lower center of the motor accommodating part 310.

A plurality of sound-absorbing holes (not illustrated) in which is perforated may be formed in the lower portion 315 of the motor accommodating part 310. A sound absorbing material (not illustrated) corresponding to a plurality of sound absorbing holes may be attached to the inner side of the motor accommodating part 310. According to the plurality of sound-absorbing holes and sound-absorbing material, it is possible to minimize the flow noise.

The guide vane 330 may extend from an outer circumferential surface of the motor accommodating part 310 to an inner circumferential surface of the outer wall 320. A plurality of the guide vanes 330 may be spaced apart along the circumferential direction.

The guide vane 330 may guide the air introduced into the guide passage 335 of the diffuser 300 upward through the fan 210.

Specifically, the air introduced by the suction part 13 and passed through the filter 40 flows upward by the flow pressure generated through the rotation of the fan 210. The air flowing upward may rise in an oblique direction while passing through the fan 210. The air rising in the oblique direction is introduced into the guide passage 335 of the diffuser 300, and the plurality of guide vanes 330 disposed in the guide passage 335 may guide the air introduced into the guide passage 335 upward.

Meanwhile, most of the air rising in an oblique direction through the blade 215 may have a fluidity component in a circumferential direction and a fluidity component in a radial direction. Accordingly, the air passing through the blade 215 may flow upward while forming a rotating vortex airflow.

The plurality of guide vanes 330 may offset the fluid component forming the vortex airflow to guide the air to rise stably.

That is, the velocity component of the air passing through the guide vane 330 may decrease in radial and circumferential directions. On the other hand, the relative axial component, that is, the upward velocity component may be large.

The distribution duct 400 may be positioned above the diffuser 300. In detail, the distribution duct 400 may be connected to an upper end of the diffuser 300. In addition, the distribution duct 400 may extend from the outer wall 320 to lower ends of the dual discharge parts 50 and 60.

Also, the inner circumferential surface of the distribution duct 400 may be formed in a curved surface so that a curved air flow is formed between the dual discharge parts 50 and 60 and the diffuser 300.

The distribution duct 400 may guide the air rising through the diffuser 300. In detail, the inside of the distribution duct 400 may form a distribution passage 410 in which the air passing through the diffuser 300 is branched to the first discharge tower 50 or the second discharge tower 60.

The distribution passage 410 may communicate with the inner space of the first discharge tower 50 and the inner space of the second discharge tower 60. That is, the distribution duct 400 may guide the air passing through the diffuser 300 to the first discharge tower 50 and the second discharge tower 60.

The support body 10 may further include a tower coupling part 19 supporting the dual discharge parts 50 and 60 and a rotation module (not illustrated) installed on the tower coupling part 19.

The tower coupling part 19 may be formed above the support body 10. In addition, the tower coupling part 19 may form an opening communicating with the distribution passage 410.

In detail, the tower coupling part 19 may form an opening in the upper surfaces of the main body cases 11 and 12 into which the first discharge tower 50 and the second discharge tower 60 are respectively inserted or supported.

The tower coupling part 19 may be formed to correspond to the number of the dual discharge parts 50 and 60. For example, the tower coupling part 19 may include a first tower coupling part into which the first discharge tower 50 is inserted or supported, and a second tower coupling part into which the second discharge tower 60 is inserted or supported.

The distribution duct 400 may extend to branch the air introduced into the distribution passage 410 into the first discharge tower 50 and the second discharge tower 60. That is, the distribution duct 400 may extend from the diffuser 300 along the flow direction of the air, and then may extend to branch to a lower end of the first tower coupling part and a lower end of the second tower coupling part, respectively.

The rotation module (not illustrated) may be installed on the inner side of the tower coupling part 19. The rotation module may be coupled with the dual discharge parts 50 and 60.

For example, the rotation module may include a first rotation module which is installed on the first tower coupling part and is coupled to the first discharge tower 50, and a second rotation module which is installed on the second tower coupling part and is coupled to the first discharge tower 50.

The rotation module may provide a rotational force to rotate the dual discharge parts 50 and 60. That is, the first discharge tower 50 and the second discharge tower 60 may rotate clockwise or counterclockwise by a rotation module respectively coupled thereto.

The first discharge tower 50 may rotate independent of the second discharge tower 60. That is, the rotation module may be provided so that the first discharge tower 50 and the second discharge tower 60 rotate independent of each other.

For example, the control part may control an operation in a dual wind mode by controlling the flow direction of the air discharged from the first discharge slit 53 and the flow direction of the air discharged from the second discharge slit 63 differently. Accordingly, it is possible to provide a comfortable air flow to more users in the room, and to perform faster indoor air circulation.

That is, the control part (not illustrated) may control the rotation direction and rotation angle of the rotation module, thereby controlling the air volume, the reach area, the strength (or wind speed), or the like of the air (hereinafter, “discharge air flow”) discharged from the dual discharge parts 50 and 60, respectively.

The rotation module may include a rotation motor (not illustrated) providing rotational force and a gear (not illustrated) connected to the rotation motor.

The rotation motor may provide a force for rotation of the dual discharge parts 50 and 60. The rotation motor may include a step motor. In addition, the rotation motor may be provided to independently rotate each discharge tower of the dual discharge parts 50 and 60. For example, the rotation motor and the gear may be provided in plurality to provide the rotational force to each of the discharge towers 50 and 60.

Meanwhile, discharge passages 52 and 62 may be formed in the discharge cases 51 and 61 of the dual discharge parts 50 and 60, respectively. That is, the discharge passages 52 and 62 for guiding air to the discharge slits 53 and 63 may be formed in the inner space of the dual discharge parts 50 and 60. The discharge passages 52 and 62 may communicate with the distribution passage 410.

The discharge passages 52 and 62 may be formed by discharge housings (not illustrated) accommodated in the discharge cases 51 and 61. For example, the discharge housing may be formed to have a narrower width toward the discharge slits 53 and 63. In this case, the discharge slits 53 and 63 may be formed at the front end of the discharge housing.

In addition, vanes 55 and 65 for guiding the vertical direction of the air passing through the discharge slits 53 and 63 may be installed in the discharge passages 52 and 62.

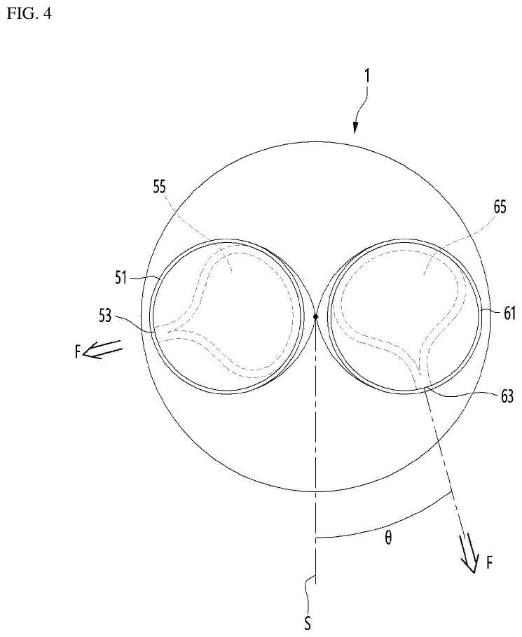

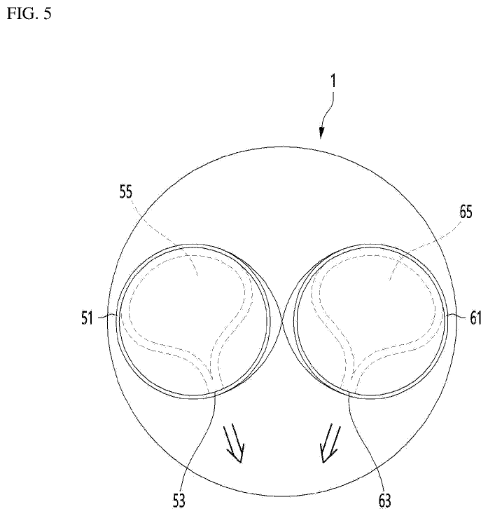

FIG. 4 is a top view illustrating a state that a dual discharge part of the blower according to the embodiment of the present disclosure discharges air individually, and FIG. 5 is a top view illustrating a state in which the dual discharge part of the blower according to an embodiment of the present disclosure discharges air to form a concentrated wind.

FIG. 4 is a diagram schematically illustrating a state of driving in the above-described dual wind mode, FIG. 5 is a diagram schematically illustrating a state of driving in the above-described concentrated wind mode.

First, referring to FIG. 4, the control part may individually control a first rotation module coupled to the first discharge tower 50 and a second rotation module coupled to the second discharge tower 60 to operate in the dual wind mode.

In this case, air F discharged from the discharge slit 53 of the first discharge tower 50 and the air F discharged from the discharge slit 63 of the second discharge tower 50 may be directed in different directions.

In the dual wind mode, based on FIG. 4, the left side of the blower 1 may cover the air discharged from the first discharge tower 50, and the right side of the blower 2 may cover the air discharged from the second discharge tower 60.

The blower 1 may set a reference line S for controlling the rotation of the first discharge tower 50 and the second discharge tower 60.

The reference line S may be defined as a line that bisects between the first discharge tower 50 and the second discharge tower 60. The reference line S may be understood as an imaginary line that bisects the blower 1 into left and right with reference to FIG. 4.

Meanwhile, the rotation angle of the first discharge tower 50 may be set to have a positive (+) value when it rotates clockwise with respect to the reference line S. For example, the rotation angle of the first discharge tower 50 may be set to be 0° when the first discharge slit 53 looks forward in parallel with the reference line S.

On the other hand, the rotation angle of the second discharge tower 60 may be set to have a positive (+) value when it rotates counterclockwise with respect to the reference line S. For example, the rotation angle of the second discharge tower 60 may be set to be 0° when the second discharge slit 63 looks forward in parallel with the reference line S.

That is, the first discharge slit 53 and the second discharge slit 63 may rotate clockwise or counterclockwise when facing in a direction parallel to the reference line S.

In addition, an angle at which the first discharge tower 50 and the second discharge tower 60 rotate to have a positive value from the reference line S may be defined as a “diffusion angle θ”.

That is, the diffusion angle θ may be understood as a rotation angle between the first discharge slit 53 and the second discharge slit 63.

Referring to FIG. 5, the blower 1 according to the embodiment of the present disclosure may control the rotation angles of the first discharge tower 50 and the second discharge tower 60 and may operate in a concentrated wind mode that may be provided to the user by increasing the air volume without increasing the rotation speed of the fan 210.

That is, the concentrated wind may be defined as a mixed air flow having a relatively high air volume by mixing the air F discharged from the first discharge slit 53 and the air F discharged from the second discharge slit 63.

A user receiving the concentrated wind may be provided with a stronger, cooler wind than the air flow discharged from one discharge part by the mixed air flow discharged from the dual discharge parts 50 and 60.

In addition, according to the concentrated wind, unlike the prior art, since the air volume increases only by rotating the dual discharge parts 50 and 60 without changing the speed of the fan, power consumption and driving noise may be reduced.

On the other hand, when a plurality of discharge parts from which air is discharged are provided, the flow noise may vary according to an angle where the air discharged from each discharge part collides with each other. That is, when the collision angle between the air is not set to an optimal value, the noise of the mixed air stream may rather increase.

Therefore, the blower 1 according to the embodiment of the present disclosure may provide concentrated wind that may form the maximum air volume while reducing noise in consideration of the angle where air collides.

That is, when the rotation speed of the fan is the same, the concentrated wind may be defined as the mixed airflow of air discharged from the dual discharge parts 50 and 60 to have a higher air volume and lower noise than the air discharged from any one discharge part.

The blower 1 according to the embodiment of the present disclosure may provide an optimal rotation angle of the dual discharge parts 50 and 60 in an operation mode (“concentrated wind mode”) for providing the concentrated wind.

For convenience of description, hereinafter, the rotation angle of the first discharge tower 50 and the rotation angle of the second discharge tower 60 for forming the concentrated wind will be described using the diffusion angle defined above.

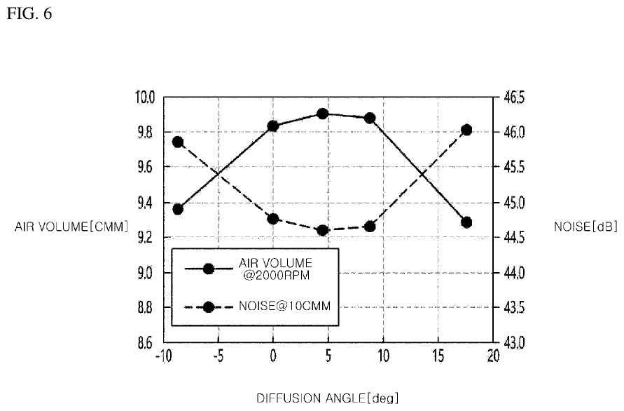

FIG. 6 is an experimental graph measuring an air volume and noise of a blower according to a change in a diffusion angle according to the embodiment of the present disclosure.

In detail, FIG. 6 is an experimental graph measuring the air volume (CMM) and noise (dB) when the diffusion angle θ of the first discharge tower 50 and the diffusion angle θ of the second discharge tower 60 change equally.

Referring to FIG. 6, when the diffusion angle θ of the first discharge tower 50 and the second discharge tower 60 is −5°, that is, when the first discharge slit 53 rotates counterclockwise to form 5° with the reference line S and the second discharge tower 60 rotates clockwise to form 5° with the reference line S, the air volume (CMM) is measured as about 9.55, and the noise (dB) is measured as about 45.25.

When the diffusion angle θ of the first discharge tower 50 and the second discharge tower 60 is 0°, that is, when the first discharge slit 53 and the second discharge slit 63 are disposed forward parallel to the reference line S, the air volume (CMM) is measured as about 9.8 and the noise (dB) is measured as about 44.55.

In addition, when the diffusion angle θ of the first discharge tower 50 and the second discharge tower 60 is 4.4°, the air volume (CMM) is measured as a maximum value of about 9.9, and the noise (dB) is measured as a lowest value of about 44.52.

Meanwhile, referring to the experimental graph, the air volume increases until the diffusion angle θ reaches about (+) 4.4°, and the noise decreases. It can be seen that the air volume rapidly decreases and the noise rapidly increases as the diffusion angle θ exceeds about 10°.

That is, the diffusion angle θ for implementing the concentrated wind may be set to be in the range of 0° or more and 10° or less. For example, in order to provide the maximum air volume and the minimum noise, the diffusion angle θ may be set to be about 4.4°.

Accordingly, when the blower 1 operates in the concentrated wind mode, the control part may control the diffusion angle θ of the first discharge tower 50 to satisfy 0° to 10°, and the diffusion angle θ of the second discharge tower 60 to satisfy 0° to 10°.

For example, the control part may control the diffusion angle θ of the first discharge tower 50 and a diffusion angle θ of the second discharge tower 60 to be equal to each other.

Meanwhile, in another embodiment, the control part may control the sum of the diffusion angle θ of the first discharge tower 50 and the diffusion angle θ of the second discharge tower 60 to satisfy 0° or more and 20° or less.

In this case, the control part may control the diffusion angle θ of the first discharge tower 50 and the diffusion angle (θ) of the second discharge tower to be equal to or different from each other within a range where the sum of the diffusion angles θ satisfies 0° to 20°.

As a result, there is an advantage in that it is possible to provide stronger and cooler wind to a user while reducing noise and power consumption compared to the conventional blower by using the dual discharge parts 50 and 60.

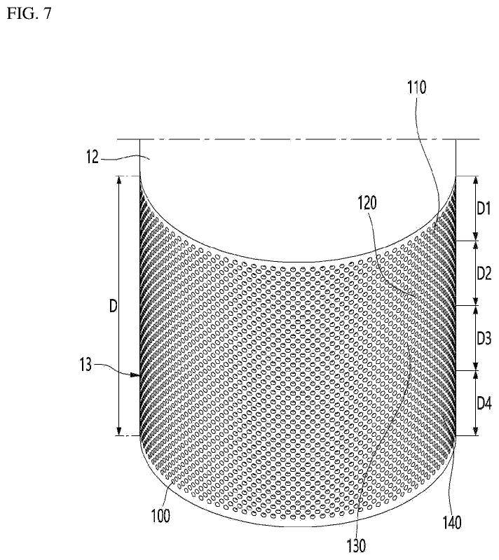

FIG. 7 is an enlarged view illustrating a suction part of the blower according to the embodiment of the present disclosure.

The blower 1 according to the embodiment of the present disclosure may include a plurality of suction holes 100 that are perforated in the suction part 13. In addition, the plurality of suction holes 100 may be formed to have a variable diameter according to the height.

On the other hand, since the fan 210 which is formed below the blower 1 and provides suction force is positioned above the suction part 13, the suction part 13 may have a flow path through which the air around the blower 1, It may have a flow path that passes through the suction part 13 in a direction toward the central axis of the blower 1 and rises along the suction flow path 45.

If it is assumed that the diameter of the suction hole 100 is the same, since the suction part 13 is formed along the outer circumferential surface of the case 12 from the ground to a predetermined height D, the speed of air (hereinafter, “suction air”) passing through the suction part 13 may increase as it approaches the fan 210. That is, the speed of the suction air may have a tendency to increase as the height of the suction hole 100 increases.

As such, when the speed of the suction air is non-uniform according to the position of the suction hole 100, there may be problems such as a decrease in suction flow rate, an increase in flow noise, and an increase in flow loss.

In order to solve the above problem, the plurality of suction holes 100 according to the embodiment of the present disclosure may be formed to have a variable diameter according to the height.

Referring to FIG. 7, the suction part 13 may be formed from the lower end of the blower 1 to a predetermined height D. For example, the predetermined height D may be set to be a maximum of 76% of the height of the case 12.

In addition, the plurality of suction holes 100 perforated in the suction part 13 may be formed to have different diameters according to the height of the suction part 13.

For example, the plurality of suction holes 100 may be formed to have a smaller diameter upward. That is, the plurality of suction holes 100 may be formed such that the suction hole positioned at the upper side has a smaller diameter than the suction hole positioned at the lower side.

In addition, the plurality of suction holes 100 may be formed to have different diameters for each section divided according to the height of the suction part 13.

For example, the plurality of suction holes corresponding to the section positioned at the upper side may be formed to have a smaller diameter than the plurality of suction holes corresponding to the section positioned at the lower side. In addition, the plurality of suction holes corresponding to the same section may be formed to have the same diameter.

In more detail, the suction part 13 may be divided into a first section D1, a second section D2, a third section D3, and a fourth section D4 according to the height. The total height of the first section D1 to the fourth section D4 may be the height D of the suction part 13.

The first section D1 may be defined as a section positioned at the top of the suction part 13. The second section D2 may be defined as a section positioned below the first section D1. The third section D3 may be defined as a section positioned below the second section D2. The fourth section D4 may be defined as a section positioned below the third section D3. That is, the fourth section D4 may be understood as a section positioned at the bottom of the suction part 13.

For example, the fourth section D4 may be set as a section having a height of 19% of the height of the case 12 from the lower end or bottom surface of the suction part 13. The third section D3 may be set as a section having a height of 19% of the height of the case 12 from the upper end of the fourth section D4, the second section D2 may be set as a section having a height of 19% of the height of the case 12 from the upper end of the third section D3, and the first section D1 may be set as a section having a height of 19% of the height of the case 12 from the upper end of the second section D2.

As described above, the plurality of suction holes 100 may be formed to have the same diameter for each section divided according to height.

In detail, the plurality of suction holes 100 may include a plurality of first holes 110 positioned in the first section D1, a plurality of second holes 120 positioned in the second section D2, a plurality of third holes 130 positioned in the third section D3, and a plurality of fourth holes 140 positioned in the fourth section D4.

The first hole 110 may have the smallest diameter among the plurality of suction holes 100. In addition, the first hole 110 may have a smaller diameter than the second hole 120. The second hole 120 may have a smaller diameter than the third hole 130. The third hole 130 may have a smaller diameter than the fourth hole 140. The fourth hole 140 may be set to have the largest diameter among the plurality of suction holes 100.

For example, the diameter of the first hole 110 may be set to be 2.4 mm. The diameter of the second hole 120 may be set to be 3.4 mm. The diameter of the third hole 130 may be set to be 4.4 mm. The diameter of the fourth hole 140 may be set to be 5.4 mm.

That is, the plurality of suction holes 100 may have a smaller diameter as they go up in the height direction. As a result, the speed of the air sucked into the suction part 13 to pass through the filter 40 may be relatively uniform. Therefore, it is possible to reduce the flow loss and noise generated while passing through the suction part 13, and it is possible to increase the suction flow rate to the maximum.

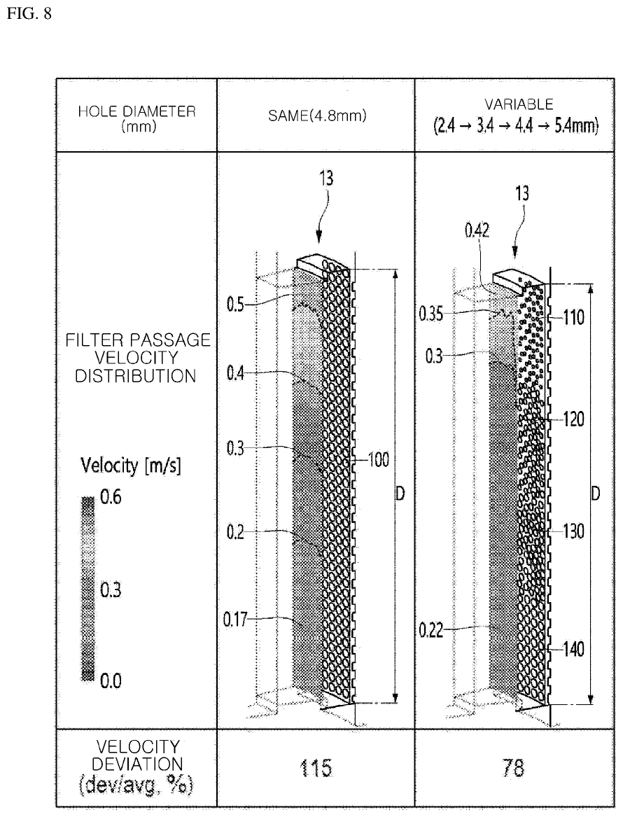

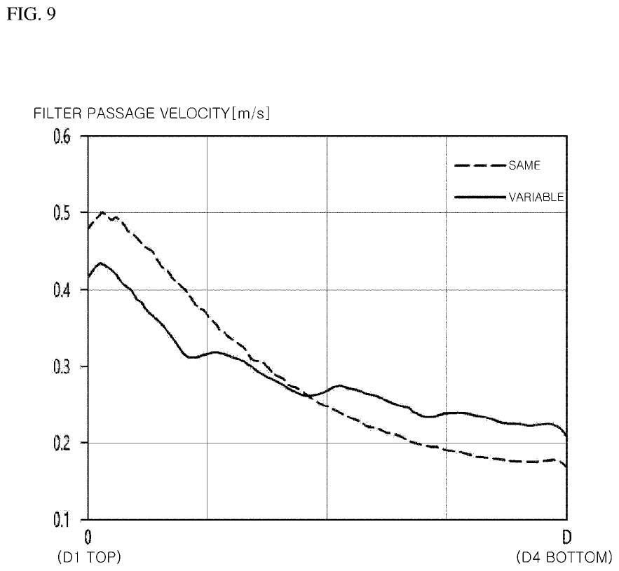

FIG. 8 is an experimental graph comparing a passage velocity distribution of air in the case where a diameter of a suction hole is the same and the case where the diameter of the suction hole varies according to the embodiment of the present disclosure, and FIG. 9 is an experimental graph comparing a passage velocity of air in the experiment of FIG. 8.

Referring to FIGS. 8 and 9, when a plurality of suction holes 100 having the same diameter as 4.8 mm are formed according to the height D of the suction part 14, it can be seen that the speed of the air sucked to pass through the filter 40 becomes slower as it goes downward.

That is, when the diameters of the plurality of suction holes 100 are the same as 4.8 mm, the maximum speed in the first section D1 is measured as about 0.5 m/s, and the minimum speed in the fourth section D4 is measured as about 0.17 m/s.

When the diameters of the plurality of suction holes 100 are the same as 4.8 mm, the speed deviation obtained by dividing the difference between the maximum speed and the minimum speed by the average value is 115.

On the other hand, when the diameters of the plurality of suction holes 100 are formed differently along the height direction, that is, when the diameter of the first hole 110 positioned in the first section D1 is 2.4 mm, the diameter of the second hole 120 positioned in the second section D2 is 3.4 mm, the diameter of the third hole 130 positioned in the third section D3 is 4.4 mm, and the diameter of the second hole 120 positioned in the fourth section D4 is 5.4 mm, it can be seen that the speed of the air sucked through the filter 40 becomes relatively uniform.

Here, the diameter of the fourth hole 140 positioned in the fourth section D4 is greater than 4.8 mm in the comparative experiment, and the diameters of the first hole 110 to the fourth hole 140 positioned higher than the fourth section D4 is smaller than 4.8 mm.

That is, when the suction hole positioned in the higher section is formed to have a smaller diameter, the maximum speed in the first section D1 is measured as about 0.42 m/s, and the minimum speed in the fourth section D4 is measured as about 0.22 m/s.

When the suction hole positioned in the section with a higher height is formed to have a smaller diameter, the speed deviation obtained by dividing the difference between the maximum speed and the minimum speed by the average value is 78. That is, it can be improved by about 40% compared to the case where the diameter of the suction hole is the same. As a result, the plurality of suction holes 100 according to the embodiment of the present disclosure may make the speed of sucked air according to a height relatively uniform compared to a case having the same diameter.

1. A blower, comprising:
a support body through which a suction part is formed;
a tower coupling part which is formed above the support body and in which a rotation module is installed; a dual discharge part which is coupled to the rotation module and includes a first discharge tower and a second discharge tower extending upward from the support body to be symmetrical to each other; and
a control part which individually controls the rotation of the dual discharge part,
wherein the control part controls rotation angles of the first discharge tower and the second discharge tower so that air discharged from the first discharge tower and air discharged from the second discharge tower is mixed, and the mixed air has an air volume larger than that of the air discharged from any one of the first discharge tower and the second discharge tower.

2. The blower of claim 1, wherein the control part controls the rotation angles of the first discharge tower and the second discharge tower so that the mixed air has noise lower than that generated by the air discharged from any one of the first discharge tower and the second discharge tower.

3. The blower of claim 1, wherein the dual discharge part further includes:
a first discharge slit which is formed to extend vertically to the first discharge tower and discharges air; and
a second discharge slit which is formed to extend vertically to the second discharge tower and discharges air.

4. The blower of claim 2, wherein an imaginary reference line S that bisects between the first discharge tower and the second discharge tower is defined,
the rotation angle of the first discharge tower is 0° when the first discharge slit is directed in a direction parallel to the reference line, and
the rotation angle of the second discharge tower is 0° when the second discharge slit is directed in a direction parallel to the reference line.

5. The blower of claim 4, wherein the first discharge tower or the second discharge tower defines a rotation angle having a positive value from the reference line S as a diffusion angle, and
the control part rotates the first discharge tower and the second discharge tower, respectively, so that the diffusion angle satisfies a preset range.

6. The blower of claim 5, wherein the rotation angle of the first discharge tower has a positive value when rotating clockwise, and
the rotation angle of the second discharge tower has a positive value when rotating counterclockwise.

7. The blower of claim 5, wherein a preset range of the diffusion angle is a 0° or more and 10° or less.

8. The blower of claim 5, wherein the control part controls the diffusion angle of the first discharge tower and the diffusion angle of the second discharge tower 60 to be equal to each other.

9. The blower of claim 5, wherein the preset range of the diffusion angle is defined as a sum of the diffusion angle of the first discharge tower and the diffusion angle of the second discharge tower.

10. The blower of claim 9, wherein the sum of the diffusion angle of the first discharge tower and the diffusion angle of the second discharge tower is 0° or more and 20° or less.

11. The blower of claim 9, wherein the control part controls the diffusion angle of the first discharge tower and the diffusion angle of the second discharge tower to be equal to or different from each other within a preset range of the diffusion angle.

12. The blower of claim 1, wherein the suction part includes a plurality of suction holes that are perforated, and
the plurality of suction holes are formed to have different diameters according to a height of the suction part.

13. The blower of claim 12, wherein the support body includes a cylindrical case forming an appearance, and
the suction part is formed below the lower portion of the case along a circumferential direction.

14. The blower of claim 12, wherein a maximum height of the suction part is 76% of a height of the case.

15. The blower of claim 12, wherein the plurality of suction holes have a diameter decreasing toward the upward.

16. The blower of claim 12, wherein the plurality of suction holes are formed to have different diameters for each section divided according to the height of the suction part.

17. The blower of claim 16, wherein the suction holes positioned in the same section among the plurality of suction holes have the same diameter.

18. The blower of claim 16, wherein the suction part includes a first section positioned at a highest height according to the height of the suction part and a second section positioned below the first section, and
a diameter of the suction hole positioned in the first section is smaller than that of the suction hole positioned in the second section.

19. The blower of claim 18, wherein the suction part further includes a third section which is positioned below the second section and a fourth section which is positioned below the third section and positioned lowest, and
the suction hole positioned in the third section is greater than a diameter of the suction hole positioned in the second section and smaller than a diameter of the suction hole positioned in the fourth section.

20. The blower of claim 19, wherein the diameter of the suction hole positioned in the fourth section is greater than 4.8 mm, and
the diameters of the suction holes positioned in the first section to the third section are smaller than 4.8 mm.
